(19) United States
(12) Patent Application Publication
(10) Pub. No.: US 2006/0235932 A1
(43) Pub. Date: Oct. 19, 2006

(54) Chat server mute capability

(75) Inventors: Joseph Celi JR., Boca Raton, FL (US); Peeyush Jaiswal, Boca Raton, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/108,292

(22) Filed: Apr. 18, 2005

(51) Int. Cl. G06F 15/16

(52) U.S. Cl. 709/207

(57) ABSTRACT

A method for enhancing chat sessions to include a server based mute capability. The method can include the step of a chat server receiving a mute indicator from at least one client participating in a chat session established by the chat server. The chat server can determine from the mute indicator at least one designated participant that is to be muted. The chat server can mute communications between the designated participant and the indicator conveying participant without affecting chat server actions related to other participants of the chat session.

### BACKGROUND

1. Field Of The Invention

The present invention relates to the field of real-time communications, and, more particularly, to adding a mute capability to chat sessions.

2. Description Of The Related Art

Chatting is an Internet based communication means where multiple individuals can simultaneously participate in a real time communication by joining a chat room typically accessed through a Web site. Chat room users register for the chat room of their choice, choose a user name and password, and log into a particular room (most sites have multiple chat rooms). Inside the chat room, there generally is a list of the people currently online, who also are alerted that another person has entered the chat room. To chat, users type a message into a text box. The message is almost immediately visible in the larger communal message area and other users may respond.

Because chat room messages are spontaneous and instantly visible, there is a potential for abuse, which may or may not be intentional. One such abuse occurs when a malicious user disturbs a chat room by posting inappropriate, overly numerous, or otherwise annoying messages.

Another bothersome chat room practice sometimes referred to as lurking occurs when a user enters chat rooms unobtrusively and reads messages without actively participating in the chat discussion. While this practice is often benign and harmless, sometimes other chat participants find lurking the electronic equivalent of stalking, especially when a lurking chat user repetitively follows a targeted chat participant.

Some chat services provide private chat sessions, which can alleviate some of the above problems, especially when a desired chat communication involves two users. Private chat sessions, however, are generally impractical when large groups of individuals are involved within a chat discussion. One significant advantage of chat rooms over other communication mechanisms, such as instant messaging, is the ability of real-time discussions among a large number of participants.

A few attempts have been made to include capabilities within client interfaces that address some of the above concerns. For example, U.S. Pat. No. 6,571,234 to Knight, et al. teaches a client interface for managing online messages that permits users to designate messages from a user-designated source as “ignored”. According to Knight's teachings, messages from a designated source still appear within the client interface but they include an italicized designator of “ignored.”

Problematically, client based solutions that ignore designated messages conveyed from a chat server, still consume network bandwidth and other resources. Consequently, even when client based measures are taken to alleviate chat problems, multiple postings by a malicious user can effectively result in a denial of service type of attack that consumes available resources and otherwise negatively affects a chat participant. Additionally, conventional solutions fail to address problems associated with lurking.

### SUMMARY OF THE INVENTION

The present invention discloses a server based mute capability for chat communications in accordance with an embodiment of the inventive arrangements disclosed herein. More specifically, a mute functionality is disclosed where a chat participant can designate one or more other chat participants that are to be muted. Muting a chat participant can prevent a chat server from conveying messages originating from a muted participant and/or can prevent a chat server from conveying messages to a muted participant. In one embodiment, muted participants can be selectively excluded from chat room communications without the muted participant even being aware that they have been muted. The mute functionality can be implemented on a participant-by-participant basis. That is, one chat participant may selectively mute another, yet other chat room participants involved in a chat session can remain unaffected.

The present invention can be implemented in accordance with numerous aspects consistent with material presented herein. For example, one aspect of the present invention can include a method for enhancing chat sessions to include a server based mute capability. The method can include the step of a chat server receiving a mute indicator from at least one client participating in a chat session established by the chat server. The chat server can determine from the mute indicator at least one client designated participant that is to be muted. The chat server can mute communications between the designated participant and the indicator conveying participant without affecting chat server actions related to other participants of the chat session.

Another aspect of the present invention can include a chat server having a chat session engine and a mute function. The chat session engine can establish at least one communication forum for a plurality of session participants using Internet protocol based communications. Each participant can remotely access the chat server from a client. The chat session engine can be configured to receive messages from participants of each established communication forum and to convey the received messages to other participants of the same communication forum in real time.

The mute function can be configured to permit each client participating in a communication forum to convey a mute indicator to the chat session engine. The mute indicator can designate at least one of the session participants of the communication forum. Responsive to receiving the mute indicator, the chat server can perform a mute action that only affects communications between the designated session participant and the indicator conveying participant. The mute action can be uni-directional or bi-directional. That is, the mute action can cause the chat server to not convey messages from the designated participant to the indicator conveying participant and/or can cause the chat server to not convey messages from the indicator conveying participant to the designated participant.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system including a chat server with mute capabilities in accordance with an embodiment of the inventive arrangements disclosed herein.

FIG. 2 is a flow chart of a method for enhancing chat sessions to include a server based mute capability in accordance with the inventive arrangements disclosed herein.

### DETAILED DESCRIPTION OF THE INVENTION

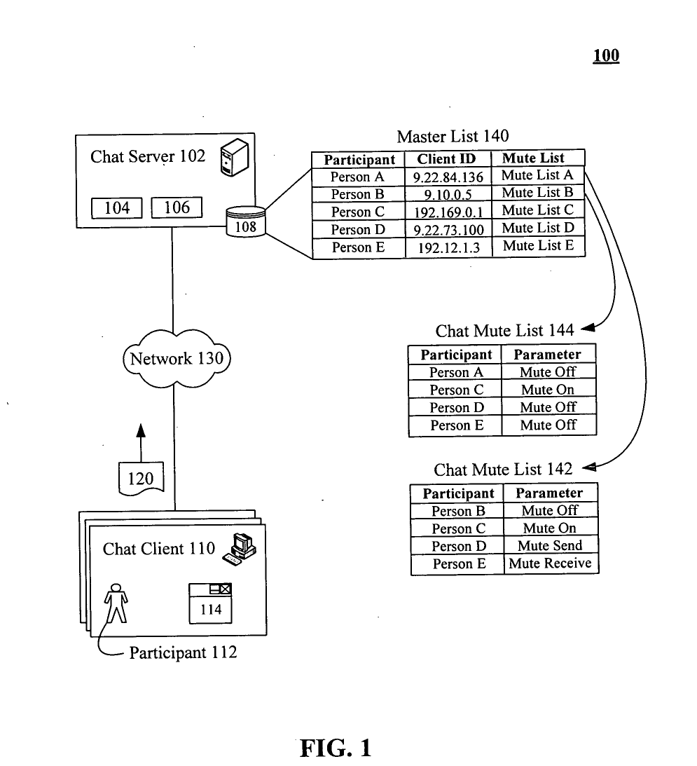

FIG. 1 is a schematic diagram of a system 100 including a chat server with mute capabilities in accordance with an embodiment of the inventive arrangements disclosed herein. System 100 includes a chat server 102 communicatively linked to one or more chat clients 110 via network 130.

Network 130 can represent any communication mechanism capable of conveying digitally encoded information. Network 130 can, for example, include a telephony network like a public switched telephone network (PSTN) or a mobile telephone network, a computer network such as a local area network or a wide area network, a cable network, a satellite network, a broadcast network, and the like. Further, the network 130 can use wireless as well as land based communication pathways.

The chat server 102 can be a server that facilitates simultaneous live electronic discussion. That is, chat server 102 can establish one or more communication forums where a group of participants can exchange messages in real time using Internet protocol based communications. A communication forum provided by the chat server 102 can be an online area, electronic venue, or virtual room (often referred to as a chat room) where people can broadcast messages to other people participating within the same forum. The exchanged messages can include text, audio, voice, graphics, and video. The forums provided by chat server 102 can include moderated, un-moderated, public, and private forums.

The chat server 102 can include a chat session engine 104, a mute function 106, and a session data store 108. The chat session engine 104 can perform programmatic actions necessary to establish live communication sessions for session participants. These programmatic actions include adding and removing participants 112 to and from a chat forum, conveying messages among chat session participants, and performing other necessary maintenance actions for the chat server 102.

The mute function 106 can be a function of the chat server 102 that permits the chat server 102 to perform a mute action in response to a request from a chat client 110. A mute action can be a bi-directional or uni-directional action, meaning that the mute action can be selectively applied to block incoming messages and/or to block outgoing messages.

A mute action that blocks messages that the chat server 102 has received from a chat client 110 (request sending client or muting client) from being conveyed to a muted recipient (the designated client specified within a mute request) can be referred to as a send block action. A mute action that blocks messages that the designated client originates so that these messages are not conveyed to the muting client can be referred to as a receive block action.

The session data store 108 can include participant specific parameters used by the chat server 102 to conduct chat operations. In one embodiment, the session data store 108 can include a master list 140 of participants currently involved in a chat session. The master list 140 can include a participant column, a client identifier column, and a mute list column.

The participant column can include an entry identifying each participant included within a communication forum, such as persons A-E. The client ID column can include identifiers for the networked computing devices from which participants access the chat server 102. The mute list column can reference a participant specific mute list for each participant specified in the master list 140. For example, person A can be associated with chat mute list 142 and person B can be associated with chat mute list 144.

Chat mute list 142 and 144 can be used to maintain participant established mute parameters. Chat mute list 142 specifies that messages to and from person B are to be permitted, messages to and from person C are to be blocked, outgoing messages for person D are to be blocked yet incoming messages from person D are to be permitted, and incoming messages from person E are to be blocked yet outgoing messages to person E are to be permitted.

Chat mute list 144 can specify that incoming and outgoing messages are to be permitted to persons A, D, and E, and incoming and outgoing messages are to be blocked from person C.

One or more chat clients 110 can utilize the communication forums provided by the chat server 102. A chat client 110 can include a computing machine, such as a personal computer, that includes a software application 114 for accessing the chat server 102. The software application 114 can, for example, be a Web browser that accesses a Web site associated with a communication forum maintained by the chat server 102. A participant 112 can be a user of the chat client 110 that utilizes the software application 114 to interface with the chat server 102.

In one configuration, the software application 114 can include a user selectable mute option (not shown). The mute option can be implemented as any graphical element, such as a button, checkbox, option window, selectable list, menu, toolbar, dialog box, and the like. The mute option can be applied against a particular chat participant. For example, a user list of participants within a chat session can be visually presented within software application 114. A user can select one or more participants and apply a mute option against that individual. When the user selects the mute option, the software application 114 can responsively generate a mute indicator 120, which is conveyed to the chat server 102.

In an illustrative example of system 100, the chat server 102 can maintain one or more ongoing chat forums. Participant 112 can access a Web site associated with chat server 102 from chat client 110 using software application 114. The participant 112 can send and receive messages associated with the chat forum that is being accessed. The chat server 102 can utilize the chat session engine 104 to send messages to participant 112 and broadcast messages from participant 112.

When the participant 112 joined the chat forum, an entry for the participant 112 can be entered into the Master list 140. For example, the entry for person B can represent participant 112. During the chat session, the participant 112 can decide that messages to and from person C, also participating in the chat forum, should be muted. Towards this end, participant 112 can activate a mute option of software application 114 and specify using this option that person C is to be muted. In response, mute indicator 120 can be conveyed via network 130 to chat server 102.

The mute indicator 120 can trigger the mute function 106 of the chat server 102. The mute function 106 can alter mute parameters within the session data store 108, which are used by chat server 102 to selectively block messages. For example, an entry within chat mute list 144 corresponding to person C can be set to a “Mute On” state. Accordingly, the chat server 102 can prevent messages originating from participant 112 from being conveyed to person C as well as prevent messages originating from person C from being conveyed to participant 112.

It should be appreciated that the arrangements shown in FIG. 1 are utilized to express the inventive concepts detailed herein, and that the invention is not to be construed as limitations of the expressed inventive concepts. For instance, although the mute parameters of session data store 108 are expressed as lists (lists 140, 142, and 144) the invention is not limited in this regard. In various contemplated embodiments, for example, mute parameters can be stored as variables within RAM, can be stored within a database structure, and can be stored as values within one or more indexed files.

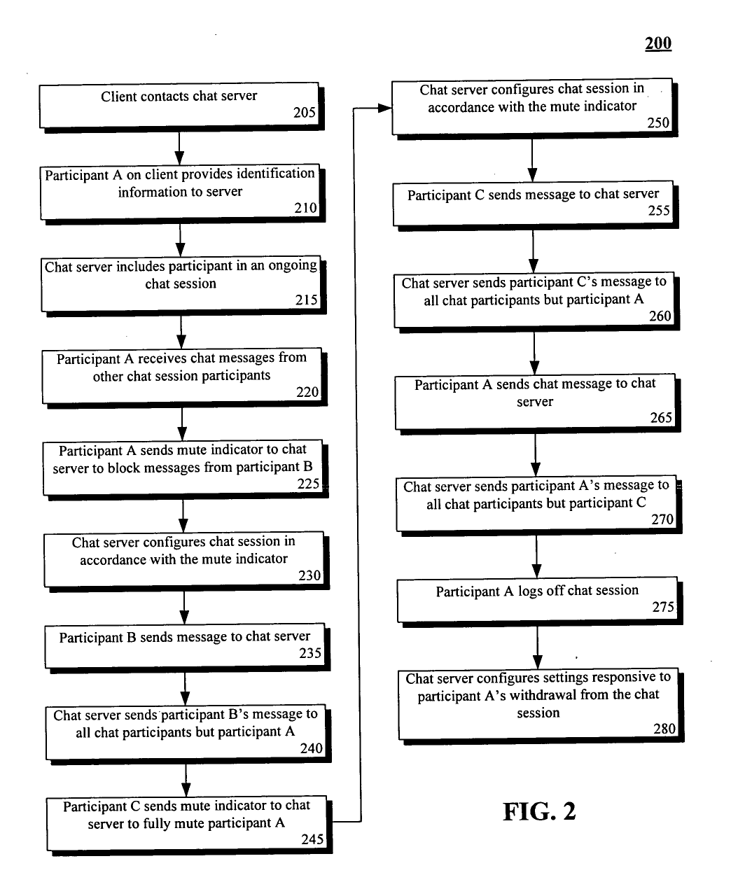

FIG. 2 is a flow chart of a method 200 for enhancing chat sessions to include a server based mute capability in accordance with the inventive arrangements disclosed herein. Method 200 can be performed in the context of any chat session, such as that detailed in system 100.

Method 200 can begin in step 205 where a client (used by participant A) can contact a chat server. In step 210, the client can provide identification information to the chat server over a communications link. The identification information can be used to enroll participant A within one or more chat sessions hosted by the chat server. Thus, in step 215, the chat server can include the participant A in an ongoing chat session.

During this chat session, participant A can send and receive messages to and from other chat session participants, as shown by step 220. For illustrative purposes these other chat session participants can include participant B and participant C.

In step 225, participant A can send a mute indicator to the chat server to block messages from participant B. In step 230, the chat server can configure the chat session in accordance with the mute indicator. After this configuration has occurred, participant B can send a message to the chat server, as shown in step 235. In step 240, the chat server can send participant B's message to all other chat participants but participant A.

In step 245, participant C can send a mute indicator to the chat server to fully mute participant A. In step 250, the chat server can configure chat session parameters in accordance with participant C's mute indicator. In step 255, participant C can send a message to the chat server. In step 260, the chat sender can convey participant C's message to all chat participants but participant A.

In step 265, participant A can send a chat message to the chat server. In step 270, the chat server can broadcast participant A's message to all chat participants but participant C. Thus, participant B will receive participant A's message, since participant A only established a block against incoming messages from participant B.

In step 275, participant A can log off the chat session. In step 280, the chat server can configure settings responsive to participant A's withdrawal from the chat session. In one embodiment, all mute settings pertaining to participant A can be cleared when participant A logs off. In another embodiment, however, the mute settings can be maintained for a designated time so as to prevent participant A from logging off and right back on to a chat forum in order to clear applied mute options, such as mute options established by others to block messages to and from participant A.

In still another embodiment, participants can establish persistent mute settings within a non-volatile storage space that are to be applied whenever the participant joins a chat forum. For example, participant C can establish a rule that participant A is to be fully muted for any chat forum including both participant C and participant A.

In other embodiment, negative rules can be established as a configuration choice by participants. For example, a chat participant can configure settings so that all participants other than those designated are muted.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for enhancing chat sessions to include a server based mute capability comprising the steps of:
a chat server receiving a mute indicator conveyed from at least one client participating in a chat session established by the chat server;
the chat server determining from the mute indicator at least one client designated participant; and
the chat server muting communications between the designated participant and the indicator conveying participant without affecting chat server actions related to other participants of said chat session.

2. The method of claim 1, wherein the muting step comprises the step of the chat server performing at least one of a message receive block action and a message send block action, wherein said message receive block action causes the chat server to not convey messages from the designated participant to the indicator conveying participant, and wherein said message send block action causes the chat server to not convey messages from the indicator conveying participant to the designated participant.

3. The method of claim 2, wherein the muting step causes the chat server to perform said message receive block action and said message send block action.

4. The method of claim 3., wherein the designated session participant is not provided an indicator that the muting step has been performed against the designated participant.

5. The method of claim 1, wherein during the chat session, the chat server enables a plurality of chat participants logged into the chat server to exchange messages in real time using Internet protocol based communications, said plurality of chat participants including said designated participant and said indicator conveying participant.

6. The method of claim 5, wherein said plurality of chat participants comprises at least three participants, and wherein said received messages comprise text messages.

7. The method of claim 1, further comprising the steps of:
the chat server receiving a message from a participant of said chat session;
said chat server querying a chat mute list established for said participant to determine if said participant has muted any other chat participants participating in said chat session; and
for each chat participant that is not muted as determined by results of said querying step, said chat server conveying said received message to each of the non-muted chat participants.

8. The method of claim 1, further comprising the steps of:
the chat server receiving a message from a participant of said chat session;
said chat server querying a chat mute list established with another participant of said chat session to determine if said another participant has muted said participant that sent said message;
when said another participant has not muted said participant, the chat server sending said another participant said message; and
when said another participant has muted said participant, the chat server not sending said another participant said message.

9. The method of claim 1, further comprising the steps of:
providing a graphical interface within said client for said chat session, said graphical interface including a user selectable mute option, wherein said mute indicator is sent to said chat server responsive to a user selecting said mute option.

10. The method of claim 1, further comprising the step of:
said chat server maintaining a master list of participants participating in said chat session that includes participant specific parameters used by the chat server to conduct said chat session, wherein at least one mute parameter used by the chat server during said muting step is programmatically linked to entries of the master list.

11. The method of claim 10, further comprising the step of:
said chat server maintaining a chat mute list for each participant in said master list, said chat mute list specifying mute options established by an associated participant to be applied by said chat server against other participants included within said master list.

12. A chat server comprising:
a chat session engine configured to establish at least one communication forum for a plurality of session participants using Internet protocol based communications, said plurality of session participants including a first chat participant and a second chat participant, wherein each session participant remotely accesses the chat server from a client, wherein said chat session engine is configured to receive messages from session participant and to convey the received messages to other session participants in real time; and
a mute function configured to perform a mute action, wherein the performance of the mute action only affects communications between a first chat participant and a second chat participant and does not affect chat server actions related to other session participants, wherein said mute action comprising at least one action selected from the group consisting of a message receive block action and a message send block action, wherein said message receive block action causes the chat server to not convey messages received from the second chat participant to the first chat participant, and wherein said message send block action causes the chat server to not convey messages received from the first chat participant to the second chat participant.

13. The server of claim 12, wherein said mute action comprises said message receive block action and said message send block action.

14. The server of claim 12, wherein the first chat participant initiates the mute action against the second chat participant, and wherein the second chat participant is not notified of the mute action.

15. The server of claim 12, comprising:
a plurality of chat mute lists each associated with one of said session participants, each chat mute list maintaining mute state information between the associated participant and other ones of the session participants.

16. The server of claim 12, wherein said plurality of session participants comprises at least three session participants, and wherein said received messages comprise text messages.

17. A machine readable storage utilized in conducting communications between a chat server and at least one client participating in a chat session established by the chat server, the machine readable storage having stored thereon a computer program having a plurality of code sections executable by a machine for causing the machine to perform the steps of:
the chat server receiving a mute indicator from the at least one client;
the chat server determining from the mute indicator at least one client designated participant; and
the chat server muting communications between the designated participant and the indicator conveying participant without affecting chat server actions related to other participants of said chat session.

18. The machine readable storage of claim 17, wherein the muting step comprises the step of the chat server performing at least one of a message receive block action and a message send block action, wherein said message receive block action causes the chat server to not convey messages from the designated participant to the indicator conveying participant, and wherein said message send block action causes the chat server to not convey messages from the indicator conveying participant to the designated participant.

19. The machine readable storage of claim 17, said plurality of code sections further causing the machine to perform the steps of:
the chat server receiving a message from a participant of said chat session;
said chat server querying a chat mute list established for said participant to determine if said participant has muted any other chat participants participating in said chat session; and
for each chat participant that is not muted as determined by results of said querying step, said chat server conveying said received message to each of the non-muted chat participants.

20. The machine readable storage of claim 17, said plurality of code sections further causing the machine to perform the steps of:
the chat server receiving a message from a participant of said chat session;
said chat server querying a chat mute list established with another participant of said chat session to determine if said another participant has muted said participant that sent said message;
when said another participant has not muted said participant, the chat server sending said another participant said message; and
when said another participant has muted said participant, the chat server not sending said another participant said message.
